(19) United States
(12) Patent Application Publication
(10) Pub. No.: US 2010/0272627 A1
(43) Pub. Date: Oct. 28, 2010

(54) Multi-Faceted Diamond and Associated Methods

(76) Inventor: Chien-Min Sung, Tansui (TW)

Correspondence Address: THORPE NORTH & WESTERN, LLP., P.O. Box 1219, SANDY, UT, 84091-1219, US

(21) Appl. No.: 12/710,823

(22) Filed: Feb. 23, 2010

Related U.S. Application Data
(60) Provisional application No. 61/171,986, filed on Apr. 23, 2009.

(51) Int. Cl. C01B 31/06; B24B 1/00

(52) U.S. Cl. 423/446; 451/41

(57) ABSTRACT

A method of making a multi-faceted diamond is provided. Such a method can include obtaining a diamond having a substantially euhedral morphology and a plurality of primary crystallographic faces and polishing a plurality of primary apexes defined by the primary crystallographic faces to form a plurality of secondary faces and secondary apexes.

### PRIORITY DATA

This application claims the benefit of U.S. Provisional Patent application Ser. No. 61/171,986, filed on Apr. 23, 2009, which is incorporated herein by reference.

### FIELD OF THE INVENTION

The present invention relates generally to methods of synthesizing and cutting diamond particles. Accordingly, the present invention involves the fields of chemistry, metallurgy, and materials science.

### BACKGROUND OF THE INVENTION

Diamonds are widely used for both gem quality and superabrasive abrading and cutting applications. The worldwide consumption of diamond particles currently exceeds 400 metric tons. In the area of superabrasive particles, for example, common tools which incorporate superabrasive particles include cutting tools, drill bits, circular saws, grinding wheels, lapping belts, polishing pads, and the like. In general, diamond grits can be classified into three distinct size ranges: coarse mesh saw grits (U.S. mesh 18 to 60 or 1 mm to 0.23 mm) for sawing applications, medium sized grinding grits (U.S. mesh 60 to 400, 230 microns to 37 microns) for grinding applications, and fine powder of micron diamond (U.S. mesh <400 mesh) for polishing applications.

Diamonds are typically formed under ultrahigh pressure, e.g., about 5.5 GPa, and high temperature, e.g., 1300° C. The quality of diamond is typically controlled by the diamond growth rate. Diamond grits are grown by converting graphite to diamond under catalytic action of a molten metal. The molten metal also serves as a solvent of carbon. Catalysts used to synthesize diamond often include iron, nickel, cobalt, manganese or their alloys. The growth rate of diamond is controlled by pressure and temperature. Typically, the lower the over-pressure required to make diamond stable and/or the lower the over-temperature needed to melt the catalyst metal, the slower the growth rate. For example, to grow saw grits in a molten alloy of iron and nickel of Invar composition (Fe65-Ni35), the pressure is about 5.2 GPa and temperature is about 1270° C.

### SUMMARY OF THE INVENTION

The present invention provides multi-faceted diamonds and associated methods. In one aspect, for example, a method of making a multi-faceted diamond is provided. Such a method can include obtaining a diamond having a substantially euhedral morphology and a plurality of primary crystallographic faces and polishing a plurality of primary apexes defined by the primary crystallographic faces to form a plurality of secondary faces and secondary apexes.

In another aspect, obtaining the diamond can further include providing a growth precursor including a carbon source and a catalyst material, the growth precursor having a diamond precursor particle arranged at least partially therein, melting the diamond precursor particle, growing the diamond by subjecting the melted diamond precursor particle and the growth precursor to temperature and pressure conditions sufficient for diamond growth. In a more specific aspect, melting the diamond precursor particle further includes associating the diamond precursor particle with an additional catalyst material, wherein the additional catalyst material is present in a quantity sufficient to melt the diamond precursor particle under diamond growth conditions prior to diamond growth. Additionally, associating the diamond precursor particle with the additional catalyst material includes coating the diamond precursor particle with the additional catalyst material. In some aspects, the additional catalyst material can be the same material as the catalyst material.

In another aspect, at least a portion of the plurality of secondary apexes can be polished to form a plurality of tertiary faces and a plurality of tertiary apexes. In yet another aspect, polishing at least a portion of the secondary apexes includes polishing substantially all of the plurality of secondary apexes. In a further aspect, the diamond particle can be polished such that each of the plurality of secondary apexes is rounded.

In some aspects, diamond can be doped to create colored diamonds or colored zones within a diamond. In one aspect, for example, growing the diamond further includes doping the diamond with a primary doping agent, wherein the primary doping agent is spatially incorporated into the diamond with the carbon source of the growth precursor. In another aspect, the diamond is used as a diamond precursor particle for a subsequent diamond growth reaction, and a subsequent growing diamond is doped with a secondary doping agent that is different from the primary doping agent, and wherein the secondary doping agent is spatially incorporated into the subsequent diamond with the carbon source of the growth precursor for the subsequent diamond growth reaction.

The present invention additionally provides multi-faceted diamonds. In one aspect, for example, a gem quality diamond is provided including a multi-faceted diamond made according to the methods described herein. In another aspect, a gem quality diamond is provided including a multi-faceted diamond made according to the methods described herein, wherein the multi-faceted diamond has a plurality of color zones within the diamond, with each zone having a different color, and wherein there are no, or substantially no, inclusion boundaries between the plurality of color zones. In another aspect, at least 50% of outer faces of the diamond are cubic (100), octahedral (111), or dodecahedral (110) crystallographic faces.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a cross section of a multi-faceted diamond prior to apex polishing, according to one embodiment of the present invention.

FIG. 2 is a cross section of a multi-faceted diamond following apex polishing, according to one embodiment of the present invention.

FIG. 3 is a front view of a diamond having color zones, according to yet a further embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features, process steps, and materials illustrated herein, and additional applications of the principles of the inventions as illustrated herein, which would occur to one skilled in the relevant art and having possession of this disclosure, are to be considered within the scope of the invention. It should also be understood that terminology employed herein is used for the purpose of describing particular embodiments only and is not intended to be limiting.

### DEFINITIONS

In describing and claiming the present invention, the following terminology will be used.

The singular forms “a,” “an,” and “the” include plural referents unless the context clearly dictates otherwise. Thus, for example, reference to “a catalyst material” includes reference to one or more of such materials, and reference to “an alloy” includes reference to one or more of such alloys.

As is used herein, “spherical-shaped” refers to an overall shape of a diamond that is generally spherical in nature, and wherein the diamond exhibits spherical symmetry. According to this definition, a spherical-shaped diamond can be a diamond having a number of facets in a spherical arrangement. In one aspect, a spherical-shaped diamond can have more than 14 outer faces. In another aspect, a spherical-shaped diamond can have more than 24 outer faces.

As used herein, “growth precursor” refers to an assembly of a catalyst material, and a raw material. A growth precursor can further include crystalline or other seeds that can be used for particle growth. A growth precursor describes such an assembly prior to the growth process, i.e. HPHT. Such growth precursors are sometimes referred to as “green bodies.”

As used herein, “inclusion” refers to formation of carbon or metal deposits instead of diamond at the interface between a growth surface of the diamond and the surrounding material. Inclusions are most often formed by the presence of substantial amounts of carbon at the growth surface of the diamond and/or inadequate control of HPHT growth conditions. Similar inclusions and defects can also be formed during cBN synthesis.

As used herein, “heating” refers to introducing heat into a material, whether the temperature of the heated material is increasing or merely maintained during heating. In contrast, “cooling” is a reduction of heating rate, even when heat continues to be introduced, albeit at a lower rate.

As used herein, “alloy” refers to a solid or liquid solution of a metal with a second material, said second material may be a non-metal, such as carbon, a metal, or an alloy which enhances or improves the properties of the metal.

As used herein, “particulate” when used particularly with respect to layers indicates that the layer is formed of particulates. Typically, particulate layers of the present invention can be loose powder, packed powder, or compacted powder having substantially no sintered particles. These particulate layers can be porous or semi-porous compacts. Compacted particulate layers can be formed using any known compaction process such as, but not limited to, wet or dry cold compaction such as cold isostatic pressing, die compacting, rolling, injection molding, slip casting, and the like. The particulate materials used in the present invention such as graphite and metal catalyst powders can be preferably handled and stored in an inert environment in order to prevent oxidation and contamination.

As used herein, “degree of graphitization” refers to the proportion of graphite which has graphene planes having a theoretical spacing of 3.354 angstroms. Thus, a degree of graphitization of 1 indicates that 100% of the graphite has a basal plane separation (d₍₀₀₀₂₎) of graphene planes, i.e. with hexagonal network of carbon atoms, of 3.354 angstroms. A higher degree of graphitization indicates smaller spacing of graphene planes. The degree of graphitization, G, can be calculated using Equation 1.

G=(3.44−d₍₀₀₀₂₎)/(3.440−3.354) (1)

Conversely, d₍₀₀₀₂₎ can be calculated based on G using Equation 2.

d₍₀₀₀₂₎=3.354+0.086(1−G) (2)

Referring to Equation 1, 3.440 angstroms is the spacing of basal planes for amorphous carbon (L_{c}=50 Å), while 3.354 angstroms is the spacing of pure graphite (L_{c}=1000 Å) that may be achievable by sintering graphitizable carbon at 3000° C. for extended periods of time, e.g., 12 hours. A higher degree of graphitization corresponds to larger crystallite sizes, which are characterized by the size of the basal planes (Lₐ) and size of stacking layers (L_{c}). Note that the size parameters are inversely related to the spacing of basal planes. Table 1 shows crystallite properties for several common types of graphite.

TABLE 1

| Graphite Type | d₍₀₀₂₎ | Lₐ (Å) | L_{c} (Å) | I₁₁₂/I₁₁₀ |
|---|---|---|---|---|
| Natural | 3.355 | 1250 | 375 | 1.3 |
| Low Temp (2800° C.) | 3.359 | 645 | 227 | 1.0 |
| Electrode | 3.360 | 509 | 184 | 1.0 |
| Spectroscopic | 3.362 | 475 | 145 | 0.6 |
| High Temp (3000° C.) | 3.368 | | 400 | 0.9 |
| Low Ash | 3.380 | 601 | 180 | 0.8 |
| Poor Natural | 3.43 | 98 | 44 | 0.5 |

As used herein, “predetermined pattern” refers to a non-random pattern that is identified prior to formation of a precursor, and which individually places or locates each crystalline seed in a defined relationship with the other crystalline seeds. For example, “placing diamond seeds in a predetermined pattern” would refer to positioning individual particles at specific non-random and pre-selected positions. Further, such patterns are not limited to uniform grid or offset honeycomb patterns but may include any number of configurations based on the growth conditions and materials used.

As used herein, “substantially euhedral” refers to a diamond with at least 50% of its surface having euhedral faces.

As used herein, “uniform grid pattern” refers to a pattern of diamond particles that are evenly spaced from one another in all directions.

As used herein, “crystalline seeds” refer to particles that serve as a starting material for growth of a larger crystalline particle. As used herein, crystalline seeds typically include diamond seeds, cBN seeds, and SiC seeds. For example, growth of superabrasive diamond is commonly achieved using diamond seeds; however cBN and/or SiC seeds can also be used to grow superabrasive diamond.

As used herein, “diamond seeds” refer to particles of either natural or synthetic diamond, super hard crystalline, or polycrystalline substance, or mixture of substances and include but are not limited to diamond, and polycrystalline diamond (PCD). Diamond seeds can be used as a starting material for growing larger diamond crystals and help to avoid random nucleation and growth of diamond.

As used herein and unless specifically defined otherwise with respect to a specific term, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

The Invention

It is to be understood that the following description is only exemplary of the principles of the present invention, and should not be viewed as narrowing the appended claims. The present invention provides multi-faceted diamonds and methods for making the same. Synthetically produced diamonds can be made having very specific morphologies that can be useful in creating such multi-faceted diamonds. In one aspect, the multi-faceted diamonds can be spherical-shaped diamonds. Additional information regarding growth of diamonds having a particular morphology can be found in U.S. Pat. No. 7,404,857, filed on Aug. 25, 2004, and U.S. Pat. No. 7,368,013, filed on Jul. 5, 2005, both of which are incorporated herein by reference.

In one aspect, multi-faceted diamonds can be diamonds that have a generally spherical shape with a plurality of outer facets. In a traditional diamond, light enters through the table face and is reflected and refracted within the diamond before exiting to create the “fires” effect seen in gem quality diamonds. In the diamonds according to aspects of the present invention, light entering into any outer face of the diamond is refracted and reflected multiple times before exiting, thus generating the “fires” to a greater extent than what is seen in traditional gem quality diamonds. In another aspect, the multi-faceted diamonds can include diamonds having apexes and edges polished down so the diamond has a more spherical morphology than a multifaceted spherical-shaped diamond. In some aspects, the removal of some apexes and edges may provide the diamond with the ability to also have light transfer along its surfaces and provide a brilliance and luster effect that enhances and compliments the “fires” from the deeper light refraction.

Such a multi-faceted diamond can be created from a synthetic diamond by polishing all or substantially all of the apexes of the diamond to form a plurality of additional faces. For example, in one aspect, a cubo-octahedral diamond that has 14 faces and 24 apexes can be polished to form a multi-faceted diamond having 38 faces by polishing each of the 24 apexes into faces. These additional faces allow entry and refraction of additional light, thus increasing the overall display of fires seen from the stone. In one aspect, for example, a gem quality diamond can have at least 50% of outer faces of the diamond are cubic (100), octahedral (111), or dodecahedral (110) crystallographic faces. It should be noted that in one aspect the synthetic starting diamond can be substantially euhedral, and thus at least 50% of its surface has euhedral faces. In another aspect, the synthetic starting diamond can have at least 75% of its surface having euhedral faces. In yet another aspect, the synthetic starting diamond can have at least 90% of its surface having euhedral faces. In a further aspect, the synthetic starting diamond can have 100% of its surface having euhedral faces.

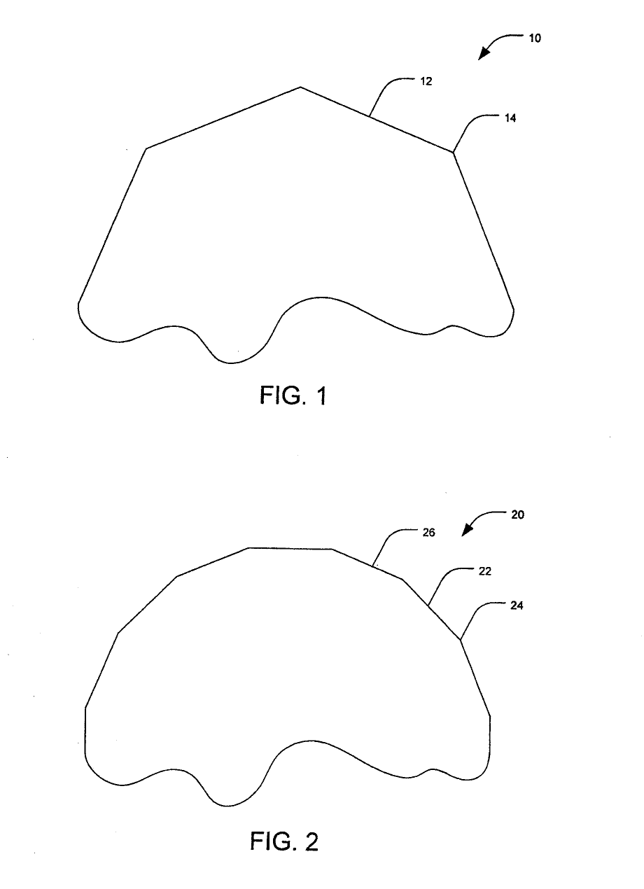

As an example, FIG. 1 shows a diamond 10 having a plurality of faces 12 and a plurality of apexes 14. FIG. 2 shows the diamond 20 following polishing of the plurality of apexes to form a plurality of secondary faces 22 and secondary apexes 24. These secondary apexes 24 are formed around the newly formed secondary faces 22. Note that a portion of the original faces 26 remains following the polishing procedure. The secondary apexes can also be polished to form a plurality of tertiary faces and tertiary apexes (not shown). Such faces further allow penetration and deep refraction of additional light thus increasing fire and brilliance. In one aspect, only a portion of the secondary apexes are polished. In another aspect, all of the secondary apexes are polished. In another aspect, at least a portion of the secondary apexes can be polished to form rounded apexes. Such a polishing procedure can also include polishing at least a portion of the edges between the apexes.

Numerous polishing procedures and post-polishing procedures are contemplated, and any method of polishing the apexes of a diamond should be considered to be within the scope of the present invention. In one aspect, scaif polishing procedures can be utilized. Additionally, diamonds can be ultrasonically polished for those aspects where the diamond is to have a more spherical morphology having apexes and edges polished to a more smooth finish. Laser ablation can also be useful to form holes through the diamonds for those aspects where a hole is to be used to secure the diamonds to a piece of jewelry such as a necklace or bracelet. In one aspect, all apexes and edges of a diamond can be removed while retaining flat portions of the faces to produce near spherical diamonds.

Numerous techniques for forming synthetic diamonds are known, and all such methods should be included within the present scope. In one aspect, however, the following methods can be used, which have been found to be useful in quickly growing large diamond particles from a diamond precursor. Following the growth of a diamond according to the aspects described below, the diamond can be utilized as a diamond precursor to grow a larger diamond, or it can be polished to form a gem quality multi-faceted diamond.

A number of diamond growing methods that can be used to synthetically form the euhedral diamonds of the present invention are known, and all such techniques should be considered to be within the present scope. Examples of such methods can be found in U.S. Pat. No. 7,172,745 filed on Jul. 26, 2004, U.S. Pat. No. 7,323,049 filed on Mar. 1, 2004, U.S. Pat. No. 7,128,547 filed on Jan. 13, 2004, U.S. Pat. No. 7,306,441 filed on Feb. 6, 2004, U.S. Pat. No. 7,371,280 filed on Aug. 24, 2005, and US. Provisional Patent Application No. 61/142,027 filed on Dec. 31, 2008, all of which are incorporated herein by reference.

The shape of the euhedral diamond obtained from the above recited processes can have a significant impact on the characteristics of the finished diamond product. In one aspect, for example, a cube-shaped diamond made according to the processes incorporated above, would have 6 faces, 8 apexes, and 12 edges. By polishing each of the 8 apexes, 8 new faces would be formed along with 24 new apexes. A new apex is formed at each edge that intersects the apex being polished, along with three new edges connecting the three new apexes together around each new face. Thus the resulting diamond would have 14 faces, 32 apexes, and 36 edges forming a roughly spherically-shaped diamond. A euhedral diamond having an octahedral shape can similarly be polished, thus forming a new face for each apex polished and a new apex for each edge intersecting the apex being polished. New edges will additionally be formed between all of the new apexes surrounding the new face. As such, a variety of diamond products can be produced that have different characteristics based on the starting configuration of the diamond being polished. It should be noted that in some aspects only a portion of the total number of apexes and/or edges of the diamond are polished, depending on the desired characteristics of the final polished diamond.

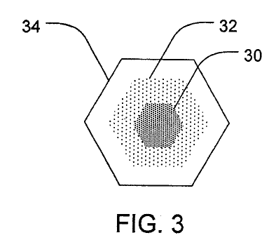

Interestingly, it should be noted that certain impurities can add color to the diamond. For example, boron-doped diamonds are blue, nitrogen-doped diamonds are yellow, titanium-doped diamonds are colorless, etc. Specifically, in some cases blue colored diamonds can be grown by doping the catalyst with boron. Yellow diamonds can be grown by doping the diamond with nitrogen from the air in the reaction chamber. Colorless diamonds can be grown by doping the catalyst with titanium. Diamonds can thus be created having imbedded zones of color within the diamond particle, depending on the type and degree of doping. Because the interrupted diamond growth processes eliminates visible boundaries between these zones of colors, interesting visual colorations can be created. For example, FIG. 3 shows a diamond having two doped zones 30, 32, and one undoped zone 34, where there are no visible inclusion boundaries between the zones.

In another aspect of the present invention, diamonds can be made with polished apeces and independent zones of color. An isothermal assembly is used to make crystals. In one aspect these crystals can be larger than 1 mm by suppressing spontaneous nucleation after 30 minutes of melting the catalyst. The diamond can then be polished and returned to the assembly and grown further with an additional layer of diamond that can be a different color. Large diamonds (>1 mm) are grown using a temperature gradient method with carbon source (e.g. micron diamond particles) heated at a temperature higher (e.g. 50 C) than the diamond seed.

### EXAMPLES

### Example 1

35/40 mesh diamond particles of high quality are supported by an uprising stream of nitrogen gas inside a funnel. The nitrogen gas is heated to about 50° C. and then pumped in from the bottom of the funnel. A slurry containing invar powder (about 325/400 mesh) is sprayed from the top of the funnel and onto the suspended diamond particles to coat the diamond particles with the invar powder. The coating on the diamond particles is dried, and the slurry is again applied. This repeated drying and coating process is continued with the diamond particles being suspended in the nitrogen stream until the thickness of the dried slurry reaches about one half of the diamond particle size. The dried slurry coated diamond particles are then removed from the coating machine.

While the diamond particles are coated with invar powder, purified graphite powder is mixed with carbonyl made nickel (about 6 microns in size, about 10 V %) in a tubular mixer. The powder is mixed with a binder and a thinner to form a growth precursor slurry that is spraying dried to form granulated particles (about half of a millimeter).

The invar powder coated diamond particles are then mixed with granulated graphite/nickel powder in such a way that, on average, diamond to diamond distance is about four times that of the diamond size. The blend is then compacted by cold pressing (or cold isostatic pressing). This compacted charge is then heat treated under hydrogen at 1000 C for 2 hours to eliminate all non carbon and non metal volatiles (e.g. water, binder, CO2 . . . etc). The purified charge is then compacted under nitrogen to form a cylindrical charge (40 mm in diameter by 30 mm in height) that can be pressed in a cubic press.

The charge is compressed to about 5.2 GPa and heated to about 130° C. After the melting of the invar that envelopes the diamond particles, each diamond will dissolve in the molten catalyst. Subsequently, the liquid becomes supersaturated by the dissolution of graphite from surrounding materials. The dissolved diamond will then grow. Temperature may be turned down (e.g. 50 C) to slow the grow rate so that inclusions in the diamonds may be minimized. After one hour of growth, each diamond is more than doubled in size so the weight increase by about 10 times.

Following growth, the apexes of the diamond particles are polished on a scaif to create secondary apexes and secondary faces.

### Example 2

35/40 diamond particles are arranged in a grid pattern by a template that is adhered to a tape. After peeling off the tape with adhered diamonds, another template with holes three times larger than the diamond particles is alighted to and stuck on the tape such that the diamond particles are aligned in the holes. With the tape on the bottom, invar powder (325/400 mesh) is sprinkled on the template to fill in the holes. A scraper is then used to remove the excess invar powder. In this case, only powder filling the hole surrounding diamond remains. The template is carefully removed, leaving diamond particles surrounded by invar powder with spacing about 4× the diamond size. A mixture of graphite and carbonyl nickel is then added. These materials are then cold pressed to form a layer with diamond and invar at the bottom. Many of these layers are stacked up and heat treated as described in Example 1. The heat treated stack is then compressed to consolidate, and then cored to form cylinders. These cylinders are pressed in cubic press as in Example 1.

### Example 3

Example 3 is the same as either Example 1 or Example 2, with the exception that the starting diamond particles are 1 mm in size.

### Example 4

Graphite and Invar are mixed in the weight ratio of 1:1 and compressed to make a cell. The cell is inserted in the hole of a gasket assembly of a cubic press. After the charge is pressed to about 5.2 GPa and heated about 1250° C. The invar is melted and subsequently nucleate diamond. The pressure is controlled in such a way that spontaneous nucleation is suppressed by the early formed diamond nuclei in their vicinity due to the effect of a carbon sink (once a nucleus is formed, the super-saturation of carbon solute in the melt decreases nearby, so additional nuclei may form at a distance four times greater than the diamond size that is intended to be grown). After about 3 hours, the cell is removed and broken apart. The pieces are soaked in acid to dissolve the metal. Residue graphite is cleaned off. The crystals (about 1 mm in size) so formed are substantially euhedral with cubo-octahedral morphology that may contain 24 apeces. These apeces are polished by a scaife. They are then pierced by a laser beam. Multiple pierced diamond crystals are combined as a necklace.

### Example 5

Same as Example 1 except that unpierced crystals are glued (e.g. by epoxy) around a large polished cubic zirconia or sapphire with facets. The diamonds can also be utilized to make figurines.

### Example 6

The unpolished crystals of Example 1 are over-coated with CVD diamond that is doped with boron using BH₃ diluted in methane that is further diluted in hydrogen with the flow rates of 1:10:100. The crystals are vibrated on the substrate so that a blue diamond coating is evenly distributed. No polishing is required for decorative jewelry.

### Example 7

Same as Example 6, except the diamond crystals are pre-coated with Cr and later laser marked to make miniscule letter, such as the letter “A” on the large faces. When coating with boron doped diamond as in Example 6, only the marked areas are coated. The remainder Cr is acid leach away.

### Example 8

The diamonds from Example 1 are coated with boron containing nickel by sputtering in vibration. The coated diamonds are then mixed with graphite and Invar for high pressure growth of boron doped diamond on yellow cores.

Thus, there is disclosed a method for synthesizing gem quality multi-faceted diamonds. The above description and examples are intended only to illustrate certain potential embodiments of this invention. It will be readily understood by those skilled in the art that the present invention is susceptible of a broad utility and applications. Many embodiments and adaptations of the present invention other than those herein described, as well as many variations, modifications and equivalent arrangements will be apparent from or reasonably suggested by the present invention and the forgoing description thereof without departing from the substance or scope of the present invention. Accordingly, while the present invention has been described herein in detail in relation to its preferred embodiment, it is to be understood that this disclosure is only illustrative and exemplary of the present invention and is made merely for purpose of providing a full and enabling disclosure of the invention. The foregoing disclosure is not intended or to be construed to limit the present invention or otherwise to exclude any such other embodiment, adaptations, variations, modifications and equivalent arrangements, the present invention being limited only by the claims appended hereto and the equivalents thereof.

What is claimed is:

1. A method of making a multi-faceted diamond, comprising:
obtaining a diamond having a substantially euhedral morphology and a plurality of primary crystallographic faces; and
polishing a plurality of primary apexes defined by the primary crystallographic faces to form a plurality of secondary faces and secondary apexes.

2. The method of claim 1, wherein obtaining the diamond further includes:
providing a growth precursor including a carbon source and a catalyst material, the growth precursor having a diamond precursor particle arranged at least partially therein;
melting the diamond precursor particle; and
growing the diamond by subjecting the melted diamond precursor particle and the growth precursor to temperature and pressure conditions sufficient for diamond growth.

3. The method of claim 1, wherein melting the diamond precursor particle further includes:
associating the diamond precursor particle with an additional catalyst material, wherein the additional catalyst material is present in a quantity sufficient to melt the diamond precursor particle under diamond growth conditions prior to diamond growth.

4. The method of claim 3, wherein associating the diamond precursor particle with the additional catalyst material includes coating the diamond precursor particle with the additional catalyst material.

5. The method of claim 1, wherein melting the diamond precursor particle further includes increasing the temperature and pressure conditions subjected to the diamond precursor particle sufficient to melt the diamond precursor particle.

6. The method of claim 1, wherein the carbon source is selected from the group consisting of graphite, diamond powder, or combinations thereof.

7. The method of claim 1, wherein the diamond precursor particle is greater than 100 microns in size.

8. The method of claim 1, wherein the diamond precursor particle is greater than 500 microns in size.

9. The method of claim 1, wherein the diamond precursor particle is greater than 1 mm in size.

10. The method of claim 1, wherein the diamond is used as a diamond precursor particle for a subsequent diamond growth reaction prior to polishing.

11. The method of claim 1, wherein growing the diamond further includes doping the diamond particle with a primary doping agent, wherein the primary doping agent is spatially incorporated into the diamond particle with the carbon source of the growth precursor.

12. The method of claim 11, wherein the diamond is used as a diamond precursor particle for a subsequent diamond growth reaction, and a subsequent growing diamond is doped with a secondary doping agent that is different from the primary doping agent, and wherein the secondary doping agent is spatially incorporated into the subsequent diamond with the carbon source of the growth precursor for the subsequent diamond growth reaction.

13. The method of claim 1, further comprising polishing at least a portion of the plurality of secondary apexes to form a plurality of tertiary faces and a plurality of tertiary apexes.

14. The method of claim 13, wherein polishing at least a portion of the secondary apexes include polishing substantially all of the plurality of secondary apexes.

15. The method of claim 13, further comprising polishing the diamond such that each of the plurality of secondary apexes is rounded.

16. A gem quality diamond, comprising a multi-faceted diamond according to claim 1.

17. The gem quality diamond of claim 16, wherein the multi-faceted diamond has a plurality of color zones within the diamond, with each zone having a different color, and wherein there are no inclusion boundaries between the plurality of color zones.

18. The gem quality diamond of claim 16, wherein at least 50% of outer faces of the diamond are cubic (100), octahedral (111), or dodecahedral (110) crystallographic faces.

19. The gem quality diamond of claim 16, further comprising a hole formed through the diamond.
